(19) United States
(12) Patent Application Publication
(10) Pub. No.: US 2006/0159875 A1
(43) Pub. Date: Jul. 20, 2006

(54) Cover for a delivery push-button of nebulising or dispensing micro-pumps

(75) Inventor: Angelo Ciriani, Buenos Aires (AR)

Correspondence Address: YOUNG & THOMPSON, 745 SOUTH 23RD STREET, 2ND FLOOR, ARLINGTON, VA, 22202, US

(73) Assignee: EMSAR S.P.A., SAN GIOVANNI TEATION (IT)

(21) Appl. No.: 10/547,421

(22) PCT Filed: Feb. 27, 2004
(86) PCT No.: PCT/IT04/00092

§ 371 Date: Aug. 29, 2005

(30) Foreign Application Priority Data
Mar. 4, 2003 (IT) RM2003 U 000046

(51) Int. Cl. B31B 45/00

(52) U.S. Cl. 428/34.1; 428/131

(57) ABSTRACT

A cover for a delivery push-button of nebuliser or dispenser micro-pump, provided with a hole (22) to allow the passage of the product dispensed by the nozzle of a delivery push-button (1), comprises an annular band (2) having a terminal edge that is curved inwardly to constitute an abutment flange (23) on the top of the delivery push-button (1).

### TECHNICAL FIELD

The present invention relates to a cover for a delivery push-button of nebulising or dispensing micro-pumps.

### BACKGROUND ART

Covers commonly used for this purpose are substantially caps. Such cap has lateral cylindrical wall, holed in the point of exit of the nebulised or dispensed product, and a planar or variously contoured top. They are fitted on the delivery push-button, thereby covering its entire visible surface.

Obtained by drawing, said covers are generally made of coloured aluminium, and therefore they have a rather elegant aesthetic finish. Together with other “covering” elements, such as the so-called cash—used to cover the system for coupling the nebuliser pump onto the bottle whereto it is applied—current covers made of coloured metal are employed with the sole purpose of enhancing the appearance of the micro-pump, especially when it is used on perfumes or cosmetic products.

On the other hand, the use of dispensers lacking the aforesaid metallic cover is also common. Such dispensers can have several shapes and sizes, sometimes also studied to improve the ergonomics of the product, as well as its appearance: for example, oftentimes a recess is obtained on the top of the dispenser to favour the correct position of the index finger which exerts the pressure, or else grooves are applied to favour a better grip. To achieve such results, very rarely are interventions made on the material, whose selection is more closely linked to the mechanical requirements of the piece or to aspects of the production process, and most of the times it falls upon a sufficiently rigid polypropylene or polyethylene.

Indeed, especially on products subject to manipulation, the use of soft materials with soft-touch finish is becoming increasingly widespread, which in addition to enhancing the aesthetic quality of the product, also make its use more comfortable and safe. When, as is the case for a delivery push-button for micro-pumps, a rigid structure must be maintained for the product, its outer surface is usually partially or totally coated with a soft-touch material, for instance by overprinting or using technologies such as bi-injection which, however, entail substantial increases in the cost and complexity of the production process.

### DISCLOSURE OF INVENTION

An object of the present invention is to improve the aesthetic and functional quality by combining different materials and colours or creating particular light effects on the bottle that bears the dispenser.

Another object is to allow an easier personalisation of the bottle with the dispenser for determined products.

The above objects are achieved, providing a cover for a delivery push-button of nebuliser or dispenser micro-pumps, provided with a hole to enable the passage of the dispensed product from the nozzle of the delivery push-button, which, from a general point of view, is characterised in that it comprises an annular band having an inwardly curved terminal edge to constitute an abutment flange on the top of the delivery push-button, when the annular band is applied on the delivery push-button.

The main advantage of the present invention is that it constitutes both a coating for a delivery push-button and, at the same, also a fastening element for the coupling of any additional inserts on the top of the delivery push-button. The convenience and practicality of use of the dispenser is thereby enhanced if, for instance, soft-touch inserts are used, whilst keeping costs low and improving the flexibility of the production process.

Inserts are useful not only to enhance the convenience of use of the dispenser, but also to bear a logo or silk-screen ads, useful for further characterisation of a product.

Another advantage of the cover according to the present invention is that, since it coats only the lateral surface of the delivery push-button, leaves free the of the delivery push-button, and if the latter is made of transparent or semi-transparent, it allows the penetration of a ray of light from above the delivery push-button.

In any case, since the abutment flange has a limited extension, it makes visible the upper surface of the dispenser, thereby obtaining an aesthetic effect relative to currently existing covers for delivery push-buttons.

Moreover, since the flange is simply curved, there are no sharp edges on the side in which the user's action is carried out.

### DESCRIPTION OF THE DRAWINGS

The invention shall become more readily apparent from the detailed description that follows of some embodiments thereof, considered together with the accompanying drawing, in which:

FIG. 1 is a partially cut axonometric view of an annular cover band for a delivery push-button according to the invention;

FIG. 2 is an axial longitudinal section of the annular band of FIG. 1;

FIG. 3 is an exploded axonometric view of a delivery push-button and of the annular band according to the invention;

FIG. 4 is an axonometric view of the delivery push-button of FIG. 3 and of the annular band, after they have been assembled;

FIG. 5 is an exploded axonometric view of a delivery push-button, of an annular band and of a covering insert according to the invention;

FIG. 6 is an axonometric view of the delivery push-button, of the annular band and of the covering insert, after they have been assembled.

### DESCRIPTION OF THE ILLUSTRATIVE EMBODIMENTS

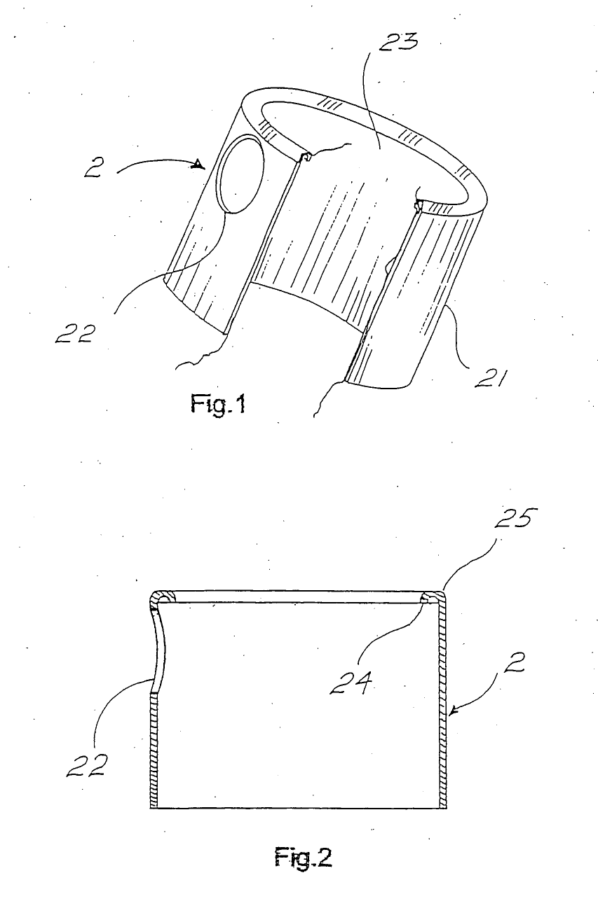

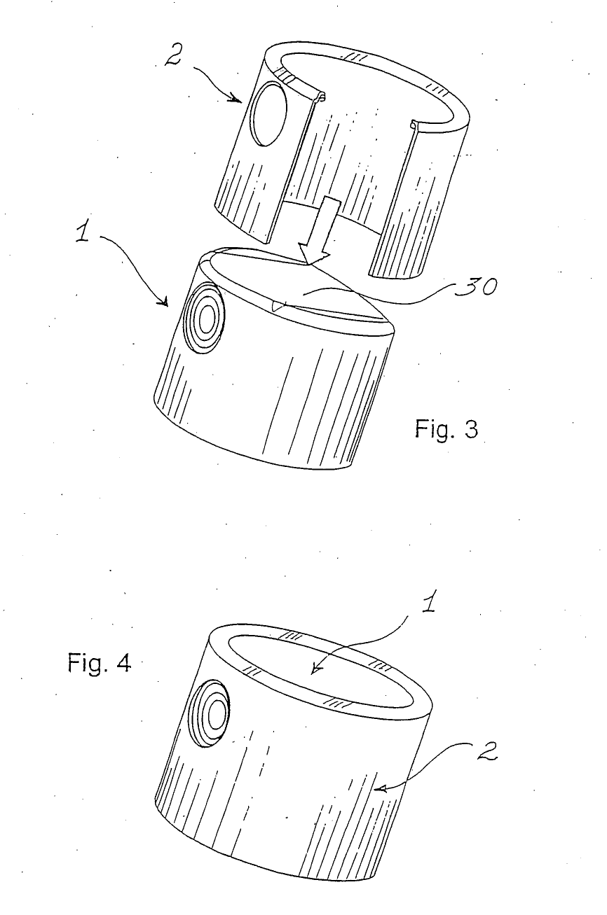

With reference initially to FIGS. 1 and 2, a partial axonometric and axially sectioned view of an annular band 2 according to the invention is shown, whilst FIGS. 3 and 6 also show an axonometric view of a conventional delivery push-button and an insert to be positioned on the delivery push-button, respectively designated by the numbers 1 and 3.

The description that follows refers to a particular embodiment in which the annular band has a straight cylindrical wall 21 whereon is obtained, in an appropriate position, a hole 22 which enables the passage of the product, nebulised or dispensed by the nozzle of the delivery push-button. A terminal edge of the annular band 2, the upper one in FIG. 1, is folded inwards to form a flange 23 with an abutment plane 24, destined to come in contact with the top 30 of the delivery push-button 1. Thus, when the annular band is inserted on the delivery push-button, as shown in FIGS. 3 and 4, the flange 23 serves as an insertion end stop. The coupling between delivery push-button and annular band takes place by interference, or by gluing, or by other means not further specified herein.

In the proposed embodiment, the flange 23 is obtained by folding the terminal edge inwards by 180°. In this way the flange 23 is sufficiently strong to provide a good pressure on the insert and assure a precise fit of the cover on the delivery push-button, thanks to the inner abutment plane 24. Moreover, the flange 23 has a rounded segment 25 in the area where the user's action is exerted to avoid inconvenience or damage when handling.

Obviously, the annular band 2 could have other than cylindrical shape, even if the delivery push-button 1 had different shape. The annular band 2 serves a coating function.

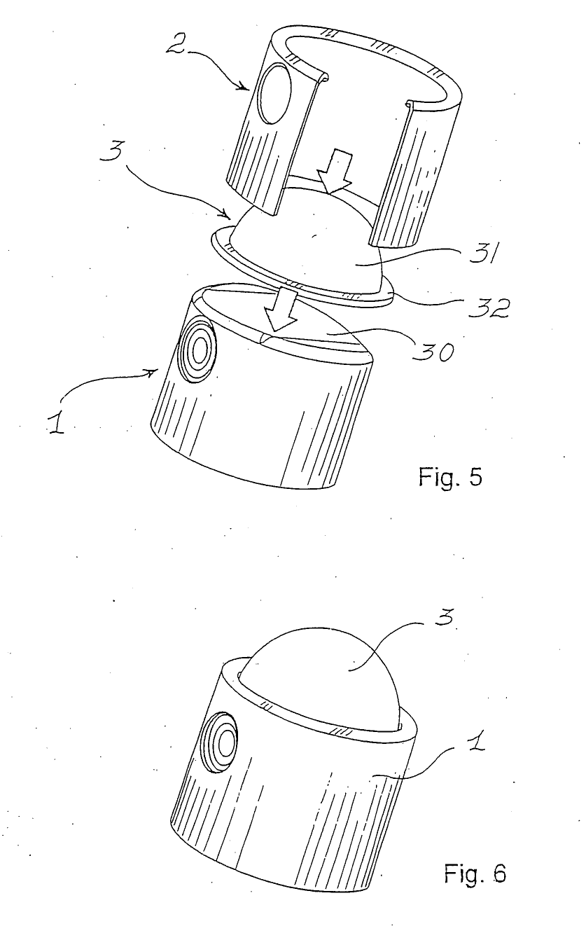

But as shown in FIGS. 5 and 6, the annular band 2 also serves a connecting function because it allows to fasten the insert 3 superposed to the delivery push-button 1. The insert is shaped as a spherical cap 31 with a flat peripheral portion 32, to be held between the top 30 of the delivery push-button 1 and the curved peripheral flange edge 23 of the annular band 2.

FIG. 6 shows the final configuration of this type of engagement of the annular band 2 which gives rise to a more complete cover of the delivery push-button 1.

It is evident that the insert 3 also could have a different shape from the spherical cap 30 shown herein, and the peripheral portion could be different as well.

1. A cover for a delivery push-button of nebuliser or dispenser micro-pumps, provided with a hole (22) to allow the passage of the product dispensed by the nozzle of a delivery push-button (1), characterised in that it comprises an annular band (2) having a terminal edge that is curved inwardly to constitute an abutment flange (23) on the top of the delivery push-button (1), when the annular band (2) is applied on the delivery push-button (1).

2. A cover as claimed in claim 1, characterised in that it further comprises an insert (3) having a flat peripheral portion (32), destined to be held between the top (30) of said delivery push-button (1) and said abutment flange (23) of the annular band (2).

3. A cover as claimed in claim 2, characterised in that said insert (3) has a spherical cap (31) conformation delimited by said flat peripheral portion (32).

4. A cover as claimed in claim 2, characterised in that the annular band (2) is cylindrical and the peripheral portion (32) is shaped as an annulus.

5. A cover as claimed in claim 1, characterised in that said annular band (2) is mounted on the delivery push-button (1) by means of an interference coupling.

6. A cover as claimed in claim 1, characterised in that said annular band (2) is mounted on the delivery push-button (1) by means of gluing.
